(19) United States
(12) Patent Application Publication
(10) Pub. No.: US 2012/0141797 A1
(43) Pub. Date: Jun. 7, 2012

(54) Zwitterion-Linker Coatings for Nano-objects in Solutions of Multivalent Counterions

(75) Inventors: William B. Sherman, Sound Beach, NY (US); Thilak K. Mudalige, Little Rock, AK (US); Oleg Gang, Setauket, NY (US)

(73) Assignee: Brookhaven Science Associates, LLC, Upton, NY (US)

(21) Appl. No.: 13/090,884

(22) Filed: Apr. 20, 2011

Related U.S. Application Data
(60) Provisional application No. 61/326,464, filed on Apr. 21, 2010.

(51) Int. Cl. B32B 5/16; C09D 7/12; B82Y 30/00

(52) U.S. Cl. 428/403; 106/287.2; 977/773; 977/742; 977/762

(57) ABSTRACT

The disclosure is directed to nanoparticles used in creating nanostructure complexes in the presence of divalent cations. In particular, the disclosure is directed to nanoparticles that are coated with zwitterions and linker portions in a manner that facilitates nanostructure complex assembly while reducing or preventing non-specific spontaneous aggregation of nanoparticle in the presence of divalent cations. The disclosure also provides a method for preparing a nanoparticle coating of the present invention. Furthermore, the disclosure provides a method for assembling nanostructure complexes using coated nanoparticles with a scaffold.

### CROSS-REFERENCE TO RELATED APPLICATIONS

This application claims the benefit of U.S. Provisional Application No. 61/326,464, filed Apr. 21, 2010, which is incorporated herein by reference in its entirety.

### STATEMENT OF GOVERNMENT RIGHTS

This invention was made with Government support under contract number DE-AC02-98CH10886, awarded by the U.S. Department of Energy. The Government has certain rights in the invention.

### BACKGROUND

I. Field of the Invention

The invention generally relates to structural nanotechnology. More specifically, nanostructure complex assemblies are provided utilizing nanoparticles coated with zwitterions and linker portions of biological or non-biological origin.

II. Background of the Related Art

Chemistry and biotechnology have evolved so that small molecules and macromolecules can be assembled into complex structures. These structures can be used to produce a vast array of useful compounds that can be utilized in a variety of applications.

The development of structural nucleic acid nanotechnology has been facilitated by the advancement of nucleic acid synthesis technology. For example, technology has progressed such that deoxyribonucleic acid (DNA) of any desired sequence can be synthesized up to about 200 bases in a single strand. These synthetic strands of DNA can self-assemble into complex, branched structures and mechanical assemblies. The features of these assemblies can be approximately two nanometers in size, which is equivalent to the width of a DNA double helix (See, for example, Mao, C. D.; Sun, W. Q.; Seeman, N. C., “Designed two-dimensional DNA Holliday junction arrays visualized by atomic force microscopy,” Journal of the American Chemical Society 121(23), 5437-5443 (1999); Kumara, M. T.; Nykypanchuk, D.; Sherman, W. B., “Assembly pathway analysis of DNA nanostructures and the construction of parallel motifs,” Nano Letters 2008, 8, (7), 1971-1977; Shih, W. M.; Quispe, J. D.; Joyce, G. F., “A 1. 7-kilobase single-stranded DNA that folds into a nanoscale octahedron,” Letters to Nature 2004, 427, (6975), 618-621; Zhang, X. P.; Yan, H.; Shen, Z. Y.; Seeman, N. C., “Paranemic cohesion of topologically-closed DNA molecules,” Journal of the American Chemical Society 2002, 124, (44), 12940-12941, each of which is incorporated herein by reference in its entirety.) Accordingly, DNA nanotechnology is one of the premier techniques for forming structures in the nanometer size range because of the wide variety of possible structures that can form through assemblies driven by Watson-Crick base pairing.

Although nucleic acids are efficient at forming structures and scaffolds in the nanometer size range, nucleic acids alone lack some of the more desirable properties that are beneficial to incorporate into the structures. These desirable properties include electric, magnetic, catalytic, and other such properties. Thus, it would be beneficial to be able to attach other materials, such as nanospheres of metals or semiconductors, to nucleic acid scaffolds. Nanoparticles (NPs) have an extremely wide range of valuable functions, lending themselves to electric, magnetic, optical, and catalytic applications. Attachment of gold nanoparticles (AuNPs) to nucleic acid scaffolds has been a focus in the field (See, for example, Aldaye, F. A.; Sleiman, H. F., “Dynamic DNA templates for discrete gold nanoparticle assemblies: Control of geometry, modularity, write/erase and structural switching,” Journal of the American Chemical Society 2007, 129, (14), 4130-4131 (“Aldaye 2007”); Kiehl, R. A., “Nanoparticle Electronic Architectures Assembled by DNA,” Journal of Nanoparticle Research 2000, 2, 331; Le, J. D.; Pinto, Y.; Seeman, N. C.; Musier-Forsyth, K.; Taton, T. A.; Kiehl, R. A., “DNA-templated self-assembly of metallic nanocomponent arrays on a surface,” Nano Letters 2004, 4, (12), 2343-2347 (“Le 2004”); Sharma, J.; Chhabra, R.; Liu, Y.; Ke, Y.; Yan, H., “DNA-templated self-assembly of two-dimensional and periodical gold nanoparticle arrays,” Angew Chem Int Ed Engl 2006, 45, 730-735 (“Sharma 2006”); Zanchet, D.; Micheel, C. M.; Parak, W. J.; Gerion, D.; Alivisatos, A. P., “Electrophoretic isolation of discrete Au nanocrystal/DNA conjugates,” Nano Letters 2001, 1, (1), 32-35 (“Zanchet 2001”); Zhang, J. P.; Liu, Y.; Ke, Y. G.; Yan, H., “Periodic square-like gold nanoparticle arrays templated by self-assembled 2D DNA nanogrids on a surface,” Nano Letters 2006, 6, (2), 248-251; Zheng, J. W.; Lukeman, P. S.; Sherman, W. B.; Micheel, C.; Alivisatos, A. P.; Constantinou, P. E.; Seeman, N. C., “Metallic nanoparticles used to estimate the structural integrity of DNA motifs,” Biophysical Journal 2008, 95, (7), 3340-3348 (“Zheng 2008”); Zheng, J.; Constantinou, P. E.; Micheel, C.; Alivisatos, A. P.; Kiehl, R. A.; Seeman, N. C., “Two-dimensional nanoparticle arrays show the organizational power of robust DNA motifs,” Nano Letters 2006, 6, (7), 1502-1504 (“Zheng 2006”), each of which is incorporated herein by reference in its entirety.)

Using nucleic acids in combination with NPs has proven problematic. One of the problems relates to the properties of nucleic acids in solution. For example, branched DNA, which is typically used for structural DNA nanotechnology, has a negatively charged backbone of phosphates that generally holds multiple phosphates very close together. This property can affect the proper formation of DNA structures/scaffolds. Because of this property, divalent cations (typically 10 mM Mg²⁺) are generally required to be in solution with DNA to facilitate proper formation of DNA structures/scaffolds. (See, for example, Du, S. M.; Zhang, S. W.; Seeman, N. C., “DNA Junctions, Antijunctions, and Mesojunctions,” Biochemistry 1992, 31, (45), 10955-10963; Fu, T. J.; Seeman, N. C., “DNA Double-Crossover Molecules,” Biochemistry 1993, 32, (13), 3211-3220; LaBean, T. H.; Yan, H.; Kopatsch, J.; Liu, F.; Winfree, E.; Reif, J. H.; Seeman, N. C., “Construction, analysis, ligation, and self-assembly of DNA triple crossover complexes,” J. Am. Chem. Soc 2000, 122, (9), 1848-1860; Rothemund, P. W. K., “Folding DNA to create nanoscale shapes and patterns,” Nature 2006, 440, (7082), 297-302, each of which is incorporated herein by reference in its entirety.) It is especially important to have the divalent cations present for structures containing Holliday junctions, because these structures, junctions between four strands of DNA, are known to change shape to a more stable form in the presence of divalent counterions. (See, for example, Murchie, A. I. H.; Clegg, R. M.; von Kitzing, E.; Duckett, D. R.; Diekmann, S.; Lilley, D. M. J., “Fluorescence energy transfer shows that the four-way DNA junction is a right-handed cross of antiparallel molecules,” Nature 1989, 341, (6244), 763-766, which is incorporated herein by reference in its entirety.). Most DNA structural motifs used to date include Holliday junctions.

Unfortunately, for much the same reason that divalent cations help DNA nanostructures cohere, they strongly promote non-specific spontaneous aggregation of NPs. NPs that aggregate in this manner are not available for attaching to scaffolds. Moreover, when NPs are coated with DNA as a linker, non-specific aggregation can be further driven by the negatively charged DNA in the presence of positive divalent cations.

As a result of these issues, only a relatively small number of studies has been performed using branched DNA and NPs. The first work in the field used extremely small AuNPs that were 1.4-nm in diameter. Such AuNPs have less tendency to aggregate than larger AuNPs, but even so they needed a thick, 0.6-nm, phosphine coating to prevent aggregation in the buffer containing 10 mM magnesium chloride (MgCl₂). The structures assembled well, but this technique is constrained to tiny AuNPs, less than nm in diameter, which have a very limited range of utility, for example, being too small to scatter visible light. Attempts to use a similar strategy on larger AuNPs only worked with low concentrations of Mg (Zanchet 2001; Zheng 2008; Zheng 2006). The concentration of Mg used in these studies was about one-third the concentration typically used for creating proper DNA nanostructures (3.5 mM Mg compared to 10 mM Mg) (Zanchet 2001; Zheng 2008; Zheng 2006). In an attempt to bypass the problem of non-specific nanoparticle assembly, one group used many identical strands of DNA attached to each AuNP in a standard buffer containing 10 mM Mg. (See, for example, Le 2004; Pinto, Y. Y.; Le, J. D.; Seeman, N. C.; Musier-Forsyth, K.; Taton, T. A.; Kiehl, R. A., “Sequence-Encoded Self-Assembly of Multiple-Nanocomponent Arrays by 2D DNA Scaffolding,” Nano Letters 2005, 5, (12), 2399-2402, which is incorporated herein by reference in its entirety.) They attempted to slowly anneal the array without the AuNPs, deposit the arrays onto a surface, and then introduce the AuNPs on the array in the hope that they would rapidly stick to the array before they aggregated. The DNA strands on the NPs could bind to multiple docking sites on the scaffold which resulted in the formation of irregular patterns. While the structures are capable of assembling, the structures have little regularity. Further, these experiments only worked with a couple of different DNA binding sequences on the AuNPs, which limits their utility.

Other studies have used AuNPs with one unique binding strand, and instead of phosphine coating they used many other short non-binding DNA strands to help prevent NP aggregation (Sharma 2006). These systems used Mg concentrations up to 1 mM, which is one-tenth the concentration typically used for creating proper DNA nanostructures (Sharma 2006). Another approach was attempted in which AuNPs having a unique binding strand and many other non-binding DNA strands were added to DNA arrays in the absence of Mg ions. The results showed that the structures formed in the complete absence of Mg ions, however, this technique depended on special DNA tiles that can assemble under these conditions. (See, for example, Sharma, J.; Chhabra, R.; Cheng, A.; Brownell, J.; Liu, Y.; Yan, H., “Control of Self-Assembly of DNA Tubules Through Integration of Gold Nanoparticles,” Science 2009, 323, (5910), 112-116, which is incorporated herein by reference in its entirety.)

Non-branched DNA does not require the presence of divalent cations to cohere. Not surprisingly, a number of studies have attempted to utilize non-branched DNA to assemble AuNPs. (See, for example, Goluch, E. D.; Nam, J. M.; Georganopoulou, D. G.; Chiesl, T. N.; Shaikh, K. A.; Ryu, K. S.; Barron, A. E.; Mirkin, C. A.; Liu, C., “A bio-barcode assay for on-chip attomolar-sensitivity protein detection,” Lab on a Chip 2006, 6, (10), 1293-1299; Alivisatos, A. P.; Johnsson, K. P.; Peng, X. G.; Wilson, T. E.; Loweth, C. J.; Bruchez, M. P.; Schultz, P. G., “Organization of ‘nanocrystal Molecules’ using DNA,” Nature 1996, 382, (6592), 609-611; Mirkin, C. A.; Letsinger, R. L.; Mucic, R. C.; Storhoff, J. J., “A DNA-based method for rationally assembling nanoparticles into macroscopic materials,” Nature 1996, 382, (6592), 607-609; Nykypanchuk, D.; Maye, M. M.; van der Lelie, D.; Gang, O., “DNA-guided crystallization of colloidal nanoparticles,” Nature 2008, 451, (7178), 549-552, each of which is incorporated herein in its entirety.) While the absence of divalent cations reduces the spontaneous aggregation of NPs, the studies showed that the assemblies are mostly disordered and only a relatively limited selection of structures is possible. Other studies have attempted to replace DNA branches with alternative organic molecules that also do not require divalent cations. While this method allows the assembly of complex structures, it requires more difficult synthesis of DNA/organic composite strands (Aldaye 2007).

### SUMMARY

Recognizing the need for creating nanostructure complexes using branched DNA and NPs that do not spontaneously aggregate, one aspect of the present nanostructure complex assembly is directed to nanoparticles used in creating nanostructure complexes in the presence of divalent cations. In particular, the NPs are coated with zwitterions and linker portions in a manner that facilitates nanostructure assembly. The zwitterion and the linker portion are each separately attached to the NP. The present NP coatings reduce or prevent non-specific spontaneous aggregation of NPs in the presence of divalent cations without preventing desired attachment of the NPs to binding targets. In some embodiments, a method is provided for preparing a nanoparticle coating by attaching the linker portion to the NP, and attaching the zwitterion to the NP. Furthermore, some present embodiments provide a method for assembling nanostructure complexes using coated NPs with a scaffold.

The nanoparticles, zwitterions, linker portions, and scaffolds of the present compositions are not limited to any particular kind, shape, or composition. In one preferred embodiment, the nanoparticle is a metallic nanoparticle, the zwitterion is a thiolate zwitterion, the linker portion is a nucleic acid, and the scaffold is also a nucleic acid.

In a particularly preferred embodiment, the nanoparticle is a 5-nm diameter gold nanoparticle, the zwitterion is 3-(N,N-dimethyl(2-sulfidoethyl)ammonio)propane-1-sulfonate, the linker portion is a DNA molecule, and the scaffold is a branched DNA structure.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is an illustration of a nanoparticle coated with zwitterions and a linker portion in accordance with an embodiment of the present invention.

FIG. 2 is a graph comparing the magnesium driven aggregation of AuNPs coated with DNA and phosphine and those coated with DNA and zwitterions.

FIG. 3A is a diagram showing the base sequences and strand paths of a DNA scaffold with AuNPs coated with DNA and zwitterions according to an embodiment of the present invention. Two different methods for attaching the AuNPs to the scaffold are shown.

FIG. 3B is a model of a DNA scaffold with AuNPs coated with DNA and zwitterions according to an embodiment of the present invention.

FIG. 4A is a scanning electron microscopy (SEM) image of DNA/zwitterion-coated NPs that are not scaffolded.

FIG. 4B is a SEM image of DNA/zwitterion-coated NPs that are scaffolded.

FIG. 4C is a SEM image similar to FIG. 4B; however the linkages between the AuNP and the DNA scaffold are weaker and more flexible.

FIG. 5A illustrates a component of a Quantum Dot Cellular Automaton design showing a double crossover molecule according to an embodiment of the present invention.

FIG. 5B illustrates a component of a Quantum Dot Cellular Automaton design showing a double crossover molecule with long strands available for attaching AuNPs according to an embodiment of the present invention.

FIG. 5C illustrates a component of a Quantum Dot Cellular Automaton design showing a triple crossover molecule according to an embodiment of the present invention.

FIG. 5D illustrates a Quantum Dot Cellular Automaton design showing two vertical wire-analogs according to an embodiment of the present invention.

### DETAILED DESCRIPTION OF THE INVENTION

In the interest of clarity, in describing the invention, the following terms and acronyms are defined as provided below.

Acronyms:
NP: Nanoparticle
AuNP: Gold Nanoparticle
DNA: Deoxyribonucleic acid
RNA: Ribonucleic acid

### DEFINITIONS

Nanoparticle: Any manufactured or naturally or chemically produced structure or particle with at least one nanometer-scale dimension (i.e., 0.1 to 500 nm).
Zwitterion: A chemical compound that carries a total net charge of zero and is thus electrically neutral, but carries formal positive and negative charges on different atoms.
Linker Portion: A chemical, compound, molecule, or structure that can join or bind to another chemical, compound, molecule, or structure. The attachment between the linker portion and the portion that is being linked can be through any chemical interaction, e.g., covalent, ionic, hydrogen bonds, van der Waals bonds, etc. The linker portion does not have to interact directly with its ultimate target, that is, attachment can be through an intermediary linker.
Scaffold: A scaffold is designed, selected, or engineered to provide suitable spacing and/or flexibility between structural/functional elements and to permit interaction between the structural/functional elements, e.g., specific binding between specific binding partners, under various conditions. A scaffold may further comprise or attach to a solid support. The scaffold can comprise small molecules and/or macromolecules including nucleic acids, amino acids/peptides/proteins, fatty acids, patterned inorganic structures, etc.
Nanostructure Complex: A nanostructure complex comprises a scaffold linked to a nanoparticle. Nanostructure complexes can also contain additional levels of intricacy/detail, for example, by scaffolding and linking several nanoparticles together; and/or by comprising a scaffold containing a hybrid of DNA and protein; and/or by linking the nanoparticle to the scaffold through an intermediary linker.

One aspect of the present compositions is directed to nanostructured complex assembly, and specifically to NPs used in creating nanostructure complexes in the presence of divalent cations. In particular, some embodiments are directed to NPs that are coated with zwitterions and linker portions in a manner that facilitates nanostructure complex assembly while reducing or preventing non-specific spontaneous aggregation of NPs in the presence of divalent cations. Some embodiments also provide methods for preparing a nanoparticle coating. Furthermore, some embodiments provide methods for assembling nanostructure complexes using coated NPs with a scaffold.

### Nanoparticles

The present nanoparticles used can be of any type or size that is capable of attaching zwitterions and a linker portion. For example, the nanoparticle can be metallic, e.g., gold, silver, platinum, semiconductive, e.g., CdSe, CdTe, CdSeZnS, or magnetic, e.g., Fe₂O₃, FePt. Additionally, the NPs can be of any shape, such as spherical, rod-shaped, icosahedral, planar, tubular, etc. As used herein, unless otherwise noted, “particle” should be construed to include micro-objects (including microspheres, microrods, etc.) and nano-objects (fullerenes, quantum dots, nanorods, nanotubes, etc.). In one embodiment, the nanoparticle is metallic. In a specific embodiment, the nanoparticle is a gold nanoparticle (AuNP). In a preferred embodiment, the nanoparticle is a AuNP that is initially stabilized via a citrate coating.

The NPs can be present either free in solution or can be attached or bound to an appropriate medium. Appropriate mediums can include, for example, arrays, membranes, metals, plastics, resins, or any other material that may bind NPs without affecting their ability to bind to scaffolds.

### Linker Portion

The linker portion can comprise any linker that can facilitate nanostructure complex assembly in a specifically desired fashion. The linker portion can be comprised of small molecules or macromolecules used alone or in combination. Examples of macromolecules that can be used include nucleic acids, e.g., DNA, RNA, and combinations thereof; amino acids, e.g., traditional and modified amino acids, peptides, proteins, amino acid-nucleic acid hybrids, and combinations thereof; carbohydrates, e.g., monosaccharides, polysaccharides, oligosaccharides, and combinations thereof; or lipids, e.g., fatty acids, glycerolipids, glycerophospholipids, sphingolipids, sterol lipids, prenol lipids, saccharolipids, polyketides, fats, waxes, sterols, fat-soluble vitamins, monoglycerides, diglycerides, phospholipids, and combinations thereof.

The linker portion can be of any length, size, or dimension. For example, when the linker portion is DNA, RNA, or a peptide, the linker portion can have any number of residues and/or sequence. The length, sequence, and/or composition of the linker portion can be appropriately determined based on the given application.

The linker portion can be obtained by purifying naturally occurring compounds or can be obtained through chemical synthesis. For example, nucleic acids can be obtained from cells using known purification techniques, or can be obtained by chemical synthesis through known techniques, and/or by amplification using polymerase chain reaction (PCR) techniques. Similarly, other chemicals or compounds can be obtained through purification techniques or chemical synthesis.

In one embodiment, the linker portion is a nucleic acid or polypeptide. In a specific embodiment, the linker portion is a nucleic acid. In a preferred embodiment, the nucleic acid is DNA or RNA. The nucleic acid sequence can be any nucleic acid sequence that is capable of hybridizing to a complementary nucleic acid strand. Preferably, the nucleic acid strand does not contain a sequence that promotes unwanted self-annealing, secondary structure formation, or dimer formation.

### Linker Portion Attachment

The nucleic acids can be attached to NPs via a number of functionalization routes, including: metal-nucleic acid binding (via thiol- or amine-terminated nucleic acids chemisorption with unmodified Au, Ag, or Pt nanoparticles, etc.), organic cross-linking (via chemical coupling between amine-, thiol-, carboxylic acid-, etc., functionalized nucleic acids and particles with carboxylic acid, amine, thiol, ketone, aldehyde, etc. surface functionalization), and bio-affinity (via specific biological interactions, protein-protein, nucleic acid-protein, nucleic acid-nucleic acid, etc. between bio-functionalized nucleic acids and biologically modified particles). In one embodiment, the nucleic acid contains thiol end-groups that bind to metal, e.g., gold. Preferably, but not necessarily, the linker portion is attached to the nanoparticle prior to attachment of the zwitterion.

When DNA is used as the linker portion, the DNA can be prepared according to any known technique. In a specific embodiment, 3′ thiol-terminated DNA is synthesized on the 1 micromole scale, desalted, and lyophilized. The DNA is then suspended in 300 μL of 100 mM dithiothreitol (DTT) to separate the DNA strands that have bound to each other through their thiols. This solution is then placed on ice for 3 hours and mixed well every hour. An Illustra NAP™-5 column (available from GE Healthcare) can be used to separate the DNA from the DTT. The DNA can be stored on ice and the resulting DNA concentration can be measured using ultra-violet light absorption at a wavelength of 260 nm.

Attaching the DNA to AuNPs can be carried out according to any technique. In a specific exemplary embodiment, the attachment is carried out as follows. Obtain 300-500 μL of 5-nm diameter citrate coated AuNPs at a concentration of 5×10¹³ NPs/ml (purchased from Ted Pella, Inc.). Add prepared thiolated DNA solution, containing a total of 20-50 strands of DNA for each AuNP in solution, 10 μL at a time. Vortex strongly between each addition. The thiol groups on the DNA will displace the citrate as it binds to the NPs. It has been observed that in the presence of salt, the negatively charged DNA can pack more densely on the surface of the AuNPs. To avoid attaching too much DNA on the AuNPs, it is possible to use no salt at this stage of the preparation. The solution should then be rotated at ˜0.1 Hz at room temperature overnight. Unbound DNA and citrate can be separated from the AuNPs with an appropriate-sized cutoff filter. The AuNPs/DNA can then be suspended in 20 mM phosphate buffer (pH 8).

The amount of linker portion attached to the NPs is dependant on the specific application. The amount of linker portion should be appropriate to effectively bind to a scaffold. Additionally, the amount of linker portion should not cause an appreciable increase in non-specific spontaneous NP aggregation. Furthermore, the amount of linker portion should not completely cover the NP so as to prevent the zwitterion from also attaching. The specific amount of linker portion will further depend on the type of linker portion used.

### Zwitterion

Zwitterions are capable of frustrating the non-specific spontaneous aggregation of NPs caused by NP interaction with the Mg ions. Additionally, when the NPs are coated with zwitterions, the zwitterions reduce spontaneous aggregation driven by NPs or linkers in the presence of Mg ions.

The present zwitterion used can be any zwitterion. For example, the zwitterion can be small molecule zwitterions, salts, amino acids, organic acids, fatty acids, and the like. A non-exhaustive list is compiled in U.S. Patent Appl. Publ. No. 2009/0202816 to Schlenoff, which is incorporated herein by reference in its entirety.

In one embodiment, the zwitterion is a sulfide zwitterion. In a specific embodiment, the zwitterion is the following zwitterion-thiolate (“Compound A”):

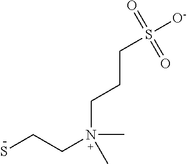

3-(N,N-dimethyl(2-sulfidoethyl)ammonio)propane-1-sulfonate

In a preferred embodiment, the more stable disulfide precursor form of Compound A is prepared, instead of the thiol form, in order to reduce intramolecular interactions and the formation of undesirable biproducts. The precursor to Compound A is 1-propanaminium, N,N′-(dithiodi-2,1-ethanediyl)bis[N,N-dimethyl-3-sulfo-], bis(inner salt) (CAS 1001232-01-4) (“pre-Compound A”).

The synthesis of pre-Compound A, can be carried out according to the method described by Rouhana, L. L.; Jaber, J. A.; Schlenoff, J. B., “Aggregation-resistant water-soluble gold nanoparticles,” Langmuir 2007, 23, (26), 12799-12801 (“Rouhana 2007”), which is incorporated herein by reference in its entirety. Briefly, in a first step (Scheme S1), 10 mmol (1.42 g) of 2-dimethylaminoethane thiol is oxidized to bis(2-dimethylaminoethyl)disulfide (1) in 70% v/v aqueous acetic acid using 20 mmol (1.99 g) of sodium perborate. The reagents are then stirred at room temperature (approximately 20° C.) for 2 hours, after which sodium hydroxide pellets are added until the disulfide separated as oil, at a pH of around 13. The latter is then extracted with ether, as colorless oil, with a yield of 65%.

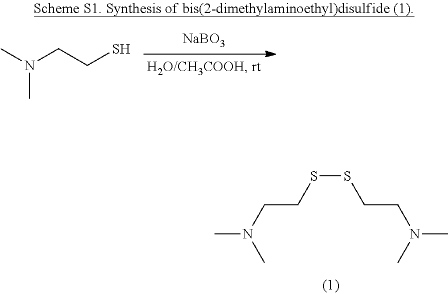

In a second step (Scheme S2), 3 mmol (0.71 g) of (1) is treated with 6.6 mmol (0.81 g) of 1,3-propane sultone in dry acetone (50 mL) at room temperature under continuous stirring for 12 hours. A white precipitate that forms is filtered, rinsed with dry acetone (3×10 mL), then dried under vacuum at 30° C. Yield: 74%.

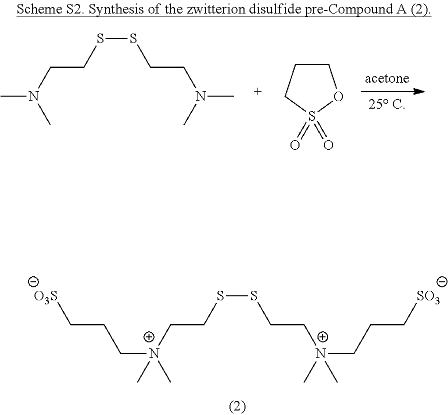

### Zwitterion Attachment

The zwitterion can be attached to the NPs by any known method. When the zwitterion is a sulfide, the attachment can be facilitated by thiol attachment chemistry. Thiols are capable of forming self-assembled monolayers (SAMs) on the surface of NPs; they thus keep the nanoparticle surface stable. When the nanoparticles are coated with citrate, the thiol bonding displaces the citrate that had been stabilizing it. To increase the water compatibility of the NPs, or to add other functionalities, other functional thiols can be used, such as tiopronin, glutathione, and thiolated poly(ethylene glycol).

In a specific embodiment, the nanoparticle is a gold nanoparticle and the zwitterion added to the AuNP is pre-Compound A. Pre-Compound A splits into two molecules of Compound A when it attaches to the nanoparticle by thiol attachment chemistry.

In a preferred embodiment, the nanoparticle is initially stabilized with a citrate coating and has the linker portion attached prior to attaching the zwitterion. In a specific embodiment, the zwitterion solution is added to a solution of AuNPs with DNA attached in a 20 mM phosphate buffer (pH 7). In a more specific embodiment, 100 μL of 10 mg/ml solution of zwitterions in 20 mM phosphate buffer (pH 7) is added to 300-500 μL of 5-nm diameter AuNPs with DNA attached at a concentration of 5×10¹³ NPs/ml in 20 mM phosphate buffer (pH 7). This solution is then mixed on a rotator over night.

After zwitterion attachment, the unbound zwitterions can be removed from the solution by filtration. In a specific exemplary embodiment, when pre-Compound A is added to the AuNPs, an appropriate-sized cutoff filter is utilized to remove the unbound zwitterions. The nanoparticles can then be rinsed three times, resuspended in water or any appropriate buffer (typically borate buffer with magnesium: 45 mM borate, 10 mM Mg(CH₃COO)₂, pH 8) and stored at 4° C.

The amount of zwitterions attached to the NPs is dependant on the amount required. The amount of zwitterions should be appropriate to prevent non-specific spontaneous NP aggregation. Nevertheless, the NPs should not be completely covered by zwitterions, which may prevent the linker portion from attaching to the NPs or displace the linker portion if it has been previously attached.

### Scaffold

The present scaffold is made of chemicals and/or compounds present in an organized core structure. Scaffolds are not limited to any particular chemical, compounds, or structure. Examples of scaffolds include small molecules and macromolecules including nucleic acids, e.g., DNA, RNA, and/or combinations thereof; amino acids, e.g., traditional and modified amino acids, peptides, proteins, amino acid-nucleic acid hybrids, and/or combinations thereof; carbohydrates, e.g., monosaccharides, polysaccharides, oligosaccharides, and/or combinations thereof; and lipids, e.g., fatty acids, glycerolipids, glycerophospholipids, sphingolipids, sterol lipids, prenol lipids, saccharolipids, polyketides, fats, waxes, sterols, fat-soluble vitamins, monoglycerides, diglycerides, phospholipids, and/or combinations thereof; and/or combinations thereof. Scaffolds may also be inorganic. They may be, for example, patterned metals, semiconductors, or insulators, zeolites, carbon nanotubes (single- or multi-walled), other nanoparticles, or nanostructure complexes previously assembled.

In a specific embodiment the scaffold is a nucleic acid. In a preferred embodiment, the scaffold is DNA or RNA that is branched, e.g., containing Holliday junctions, or unbranched. In a particularly preferred embodiment, the scaffold is branched DNA.

The scaffolds can be present either free in solution or can be attached or bound to an appropriate medium. The appropriate mediums can include, for example, arrays, membranes, metals, plastics, resins, ceramics, semiconductors, or any other material that may bind scaffolds, without disrupting their structures or binding capacities.

### Nano Structure Complex Formation

Various nanostructure complexes can be formed using the present nanostructure complex assembly. The basic unit of a nanostructure complex comprises a scaffold linked to a nanoparticle. The basic unit can be repeated in a predetermined pattern. As stated above, the NPs, zwitterions, linker portion, and scaffolds are not limited to a particular structure and can be a variety of chemicals, compounds, or materials. Accordingly, the nanostructure complexes are not limited to any particular structure, shape, or composition. The type of nanostructure complex formed depends on the chemicals, compounds, and materials used for the NPs, zwitterions, linker portion, and scaffold. Moreover, the nano structure complex can contain additional levels of intricacy. This can be accomplished when the nanoparticle, zwitterions, linker portion, and/or scaffold are composed of more than one compound. For example, a nanostructure complex can comprise a scaffold containing a hybrid of DNA and protein and/or the nanoparticle can be linked to the scaffold through an intermediary linker. In a preferred embodiment, the nanostructure complexes contain branched DNA.

The method of assembling the nanostructure complexes is not limited to any particular method. The method for assembling nanostructure complexes can be carried out under various buffer conditions. In a preferred embodiment, when the nanostructure complexes contain branched DNA, the nanostructure complexes should generally be assembled using 10 mM of divalent cations. The divalent cations can include magnesium chloride or magnesium acetate, but calcium chloride or calcium acetate may also be used. In a preferred embodiment, 2 mM ethylenediaminetetraacetic acid (EDTA) is also utilized to help protect the DNA from cleavage by iron that may be a contaminant in the system. Accordingly, when 2 mM of EDTA is present in the system, the EDTA will also bind to Mg ions. The EDTA:Mg binding will result 10.5 mM Mg available in solution (i.e., 12.5 mM Mg with 2 mM EDTA is considered 10.5 mM Mg). Acceptable buffers include, among others, borate buffer; tris, acetic acid buffer; tris boric acid buffer; and HEPES buffer.

The method for assembling nanostructure complexes can be carried out at various temperatures. For example, nanostructure complex formation and disassociation can be carried out at temperatures between about 0° C. to about 110° C. At these temperatures, if DNA is utilized, the DNA scaffold and DNA linker portion can anneal/hybridize and/or melt at different temperatures, thus facilitating nanostructure complex formation and disassociation. The appropriate temperature can be determined based on the application and/or the scaffold and linker used. In one embodiment, nanostructure complex formation can be carried out between about 0° C. to about 50° C. In another embodiment, nanostructure complex disassociation can be carried about from about 50° C. to about 110° C. In some embodiments, the nanostructure complexes are formed and/or disassociated at a temperature of about 10° C., about 20° C., about 30° C., about 40° C., about 50° C., about 60° C., about 70° C., about 80° C., about 90° C., about 100° C., or about 110° C. Temperatures may be adjusted as necessary to accommodate different elements. Thiolated DNA often dissociates from AuNPs around 70° C. Most DNA nanostructure complexes melt at temperatures below about 70° C.; exceptions include DNA tubules ligated shut. (See, for example, O'Neill, P.; Rothemund, P. W. K.; Kumar, A.; Fygenson, D. K., “Sturdier DNA Nanotubes via Ligation,” Nano Letters, 2006, 6, (7), 1379-1383, which is incorporated herein by reference in its entirety.) Also, PNA/DNA hybrids melt at higher temperatures than similar DNA/DNA structures.

### EXAMPLES

The following example is intended for illustrative purposes only and should not be considered as limiting the invention.

### Nanoparticle Coating

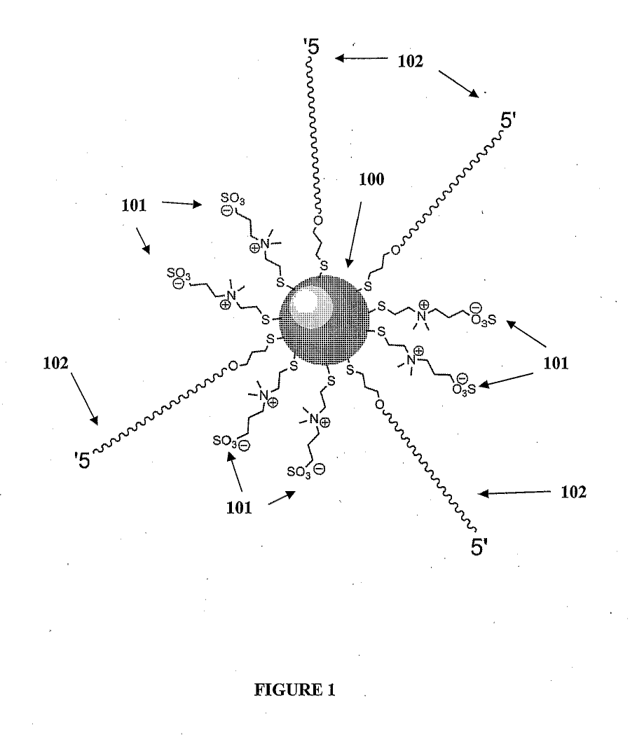

FIG. 1 is an illustration of a nanoparticle coated with zwitterions and a linker portion. Specifically, the nanoparticle shown is a 5-nm diameter gold nanoparticle (AuNP) (100). The zwitterion attached to the AuNP is 3-(N,N-dimethyl(2-sulfidoethyl)ammonio)propane-1-sulfonate (Compound A) (101) which is attached through thiol attachment chemistry. Also attached to the AuNP is a linker portion that comprises multiple copies of a DNA molecule (102).

### Comparative Data

The nanoparticle coatings of the present invention have been shown to resist non-specific aggregation that is otherwise caused by the presence of 10 mM Mg ions. The coatings also allow the NPs to be assembled onto a suitable DNA nanoscaffold in the presence of 10 mM Mg ions.

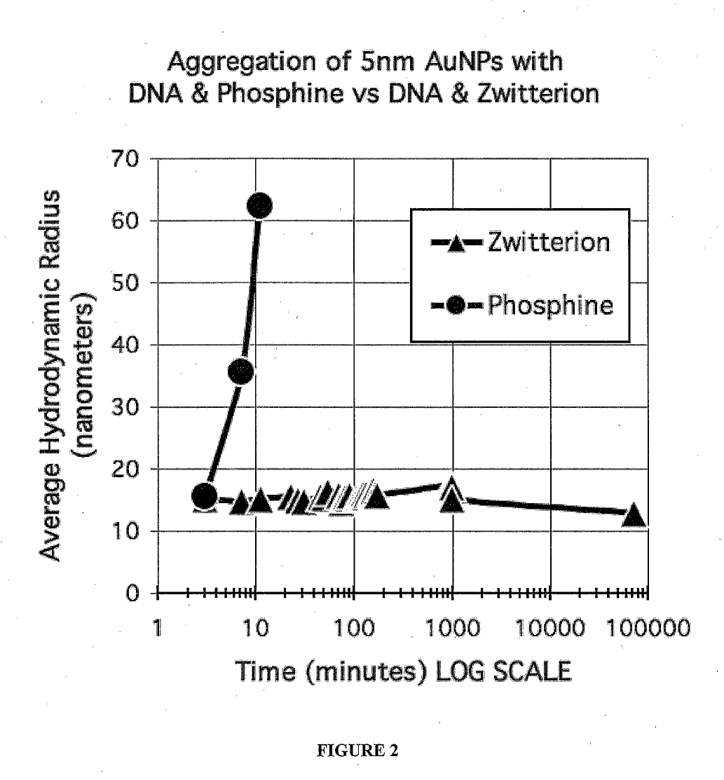

FIG. 2 provides comparative data demonstrating some advantages of the present invention. Specifically, FIG. 2 shows a comparison of room-temperature, Mg²⁺-driven aggregation of 5-nm AuNPs coated with either DNA and phosphine () or with DNA and zwitterions (▴).

In both cases, the DNA sequence used was strand T1.˜2th10(dt)+10T (SEQ ID NO:13) from Table 1 below. The zwitterions were compound A.

Briefly, the particles with phosphine were prepared as follows.

Citrate-coated AuNPs were suspended in 20 mM phosphate buffer (pH 7) with a 1000× excess of phosphine. Excess phosphine was removed by a 50-kiloDalton cut-off filter, and the resulting phosphine-coated AuNPs were resuspended in water. Then, DTT-treated, thiolated DNA was added 10 μl at a time, with strong vortexing between each addition, till the DNA concentration is 20-50 times the AuNP concentration. The solution is set to rotate at 0.1 Hz overnight. Finally excess DNA is filtered off with a 50-kilodalton cut-off filter. The particles are triply rinsed and suspended in borate buffer with magnesium (45 mM borate, 10 mM Mg(CH₃COO)₂, pH 8) just as the aggregation study began.

Briefly, the AuNPs with DNA and zwitterions were prepared as follows.

The AuNPs with thiolated DNA and compound A zwitterions were prepared as described above, and were suspended in borate buffer (45 mM borate, 10 mM Mg(CH₃COO)₂, pH 8) just prior to the start of the aggregation experiments.

The NPs for which the results in FIG. 2 were obtained had on average 5 DNA molecules per AuNP. All observations were made in borate buffer with 10 mM Mg²⁺ ions. Average hydrodynamic radius (dₕ) was observed by dynamic light scattering (DLS). The horizontal (time) scale is logarithmic, so while the particles coated with DNA and phosphine already show substantial aggregation before 8 minutes, the particles coated with DNA and zwitterions show no observable aggregation after 7 weeks.

### Scaffold

The scaffolds can be organized and/or structured by any method known in the field.

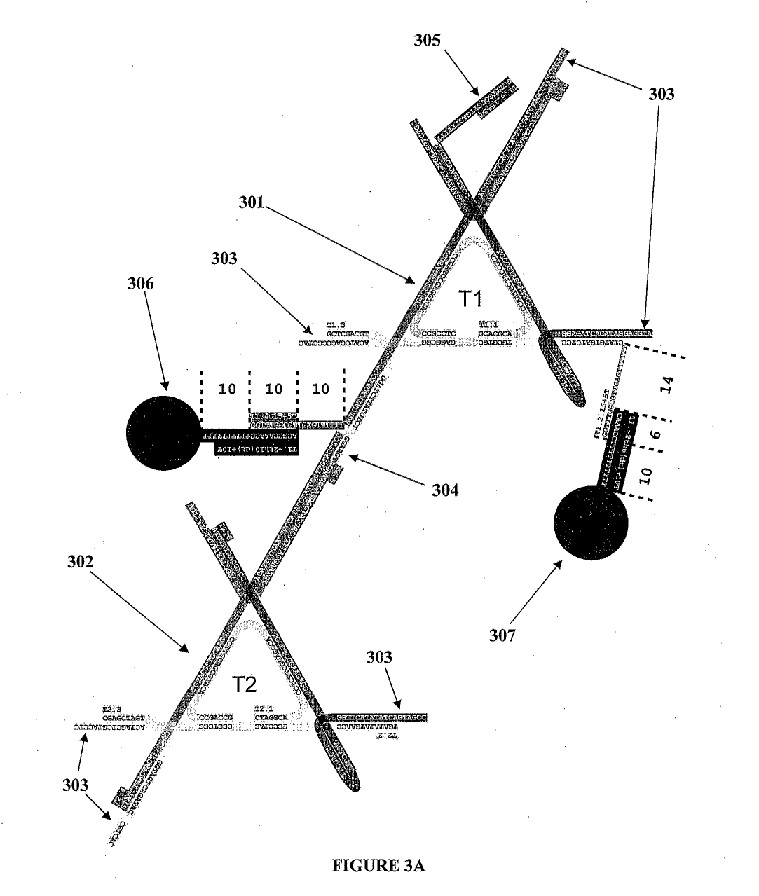

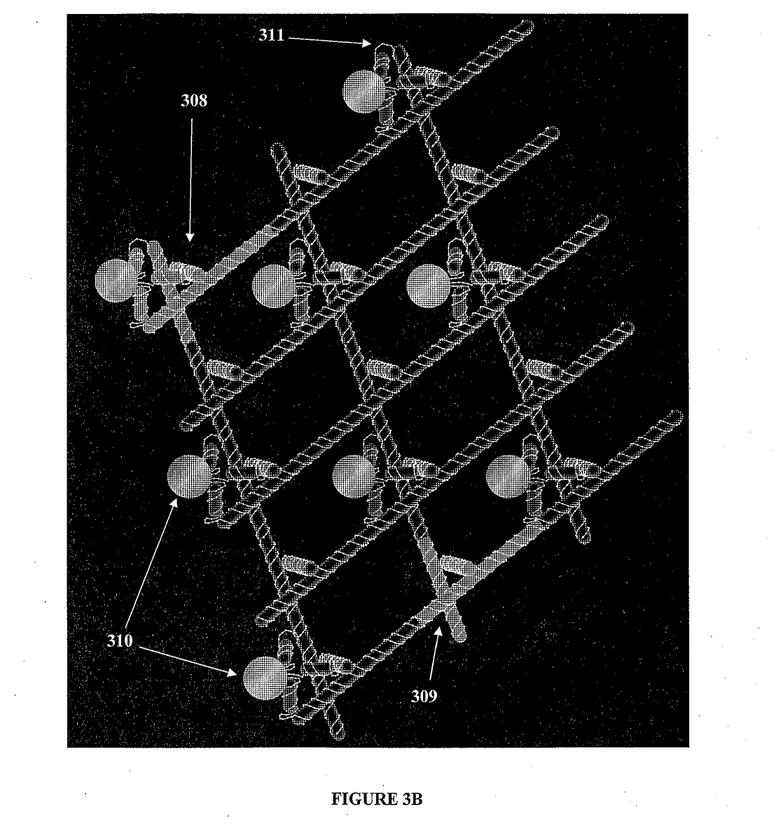

The structure in FIGS. 3A and 3B is made from the strands of DNA shown in Table 1. FIG. 3A shows the base sequence and path of each strand of DNA going through the structure (for clarity, the helical twist of the DNA is ignored in this illustration). Triangle 1 (301) and triangle 2 (302) each have 6-nucleotide single-stranded overhangs known as ‘sticky ends’ (303 and 304) that connect the triangles together to form an extended array. Sticky end 304 shows two sticky ends hybridized together to hold the two triangles shown in the correct relative positions. Triangle 1 (301) has three 20-nucleotide long single stranded overhangs (305) that are meant to serve as attachment points for three strands of DNA on a single AuNP.

The examples present two different schemes for attaching AuNPs to the array. Each AuNP (306 and 307) is shown here with just one DNA strand attached to the array for illustrative purposes. AuNP 306 depicts an attachment strategy where there are 10 nucleotides of single-stranded DNA near the AuNP, followed by a 10-base-pair connection to the array, followed by 10 more nucleotides of single-stranded DNA. AuNP 307 depicts an attachment strategy where there are 10 nucleotides of single-stranded DNA near the AuNP, followed by a 6-base-pair connection to the array, followed by 14 more nucleotides of single-stranded DNA. These two attachment styles have yielded the best arrangements of AuNPs on the scaffold observed to date.

FIG. 3B shows a space-filling model of the systems from FIG. 3A with each 5 nm diameter AuNP (310) depicted bound to three binding sites via a 10-10-10 attachment style as depicted in FIG. 3A (306). Each DNA double-helix is represented by a cylinder with two white helices running around it to indicate the DNA backbones. DNA that is not incorporated into a double helix (such as 311) only has its backbone depicted. One instance of triangle 1 is highlighted (308), including the three attachments to a AuNP (310). One instance of triangle 2 is also highlighted (309).

TABLE 1
DNA Sequences Used in Example of FIG. 3.

| | SEQ ID NO. | Strand sequence 5′ to 3′ |
|---|---|---|
| Triangle 1 | | |
| T1.1 | 1 | GCACGCACCAATCCTACCGCACCGATCCGAGGTCACCGCCTC |
| T1.2.15 + 5T | 2 | GGTTTGGCGTTGAGTTTTTTCTATGTGATCTCCTGCGTGCGAGGCGGACATCGAGCGGCTAC |
| T1.3 | 3 | GCTCGATGTGGATCTTATGTCTGGAAGT |
| T1.4.15 + 5T | 4 | GGTTTGGCGTTGAGTTTTTTAGACATAAGATCCTGACCTCGGATCGGACTGTGTTCACTCAC |
| | | TTCGATCTAGCCTCTGTGACG |
| T1.5 | 5 | AGAGGCTAGATCGAAGTGAGTGAACACAGTGGAATCTTGTGAAGGTCTGC |
| T1.6.15 + 5T | 6 | GGTTTGGCGTTGAGTTTTTTTTCACAAGATTCCTGCGGTAGGATTGGACGACTTTTGTCGTG |
| | | GAGATCACATAGGAGGTA |
| Triangle 2 | | |
| T2.1 | 7 | CTAGGCACCTCTTCGGAGGCACCTTGCAGCGTACACCGACCG |
| T2.2 | 8 | TGATATATGAACCTGCCTAGCGGTCGGACTAGCTCGTACCTC |
| T2.3 | 9 | CGAGCTAGTGGTAGTCAGATACCGTCAC |
| T2.4 | 10 | GTATCTGACTACCTGTACGCTGCAAGGACATTCCTAACCGCCATACCTATCGCTTGTACTTCC |
| T2.5 | 11 | ACAAGCGATAGGTATGGCGGTTAGGAATGTGGTCGTTATAGATGTATTGC |
| T2.6 | 12 | ATCTATAACGACCTGCCTCCGAAGAGGACTCGTTTTCGAGTGGTTCATATATCAGTAGCC |
| AuNP coating | | |
| T1.~2th10(dt) + 10T | 13 | ACGCCAAACCTTTTTTTTTT(thiol) |
| T1.~2th6(dt) + 10T | 14 | CAAACCTTTTTTTTTT(thiol) |

### Nanostructure Complex Formation

To prepare samples, the strands for triangles 1 (308) and 2 (309) were all mixed together in one tube at 750 nM concentration in borate buffer with magnesium (45 mM borate, 10 mM Mg(CH₃COO)₂, pH 8). The strands were then annealed over 12 hours from 95° C. down to room temperature to form an array. AuNPs (306) prepared as above with one or the other of the DNA sequences identified in Table 1 and zwitterions of Compound A. The AuNPs were brought to a 3.75 μM concentration. Ten microliters of the annealed array were mixed with 10 μL of the AuNPs in the borate buffer with magnesium. The solution was allowed to equilibrate for 30 minutes at room temperature. The resulting assembly of scaffolded AuNPs was then deposited on freshly cleaved mica, allowed to sit for 3 minutes, and then rinsed with 200 μL of 200 μM Mg(CH₃COO)₂, in preparation for imaging. The samples were held vertically and the liquid was absorbed off their corners with a wipe.

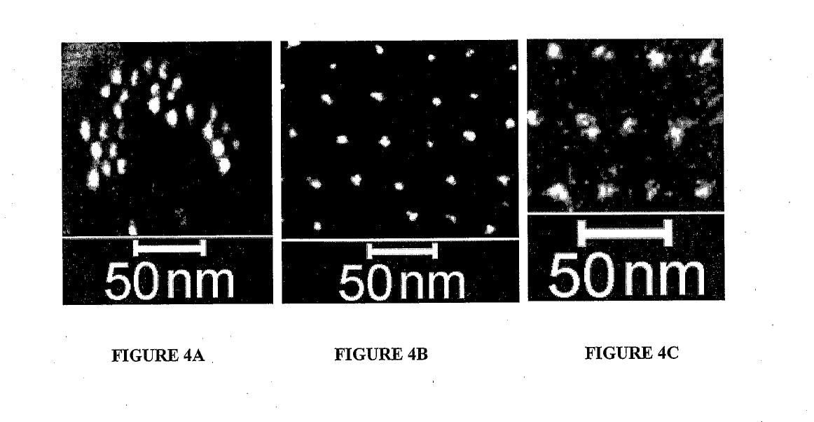

FIG. 4A shows the results of a control experiment in which no DNA scaffold was present to organize the NPs. It shows a contrast-enhanced SEM image of 5-nm AuNPs with a coating of compound A zwitterions and DNA (strand T1.˜2th10(dt)+10T (SEQ ID NO:13) from table 1) prepared as described above. The AuNPs were suspended at 1.875 μM concentration in borate buffer with magnesium (45 mM borate, 10 mM Mg(CH₃COO)₂, pH 8). They were deposited onto freshly cleaved mica, allowed to sit for 3 minutes, and then rinsed with 200 μL of 200 μM Mg(CH₃COO)₂, in preparation for imaging. The sample was held vertically and the liquid was absorbed off the corner of the sample with a wipe. Surface tension during sample drying organizes NPs, but only one structure can be formed this way, and the NPs are touching. Nearest-neighbor distance is typically about 12 nm.

FIG. 4B is a contrast-enhanced SEM image of identically treated AuNPs as shown in FIG. 4A except in this case, they were assembled on the DNA triangle scaffold shown in FIGS. 3A and B. This sample was prepared as described in paragraph [0070]. The DNA on the AuNP was strand T1.˜2th10(dt)+10T (SEQ ID NO:13) from Table 1 which should lead to a 10-10-10 style of attachment (FIG. 3A, 306). The observed nearest neighbor distance in this SEM is consistently more than twice that of the unscaffolded AuNPs shown in FIG. 4A, mostly in the 28-32 nm range. The DNA is not visible to the SEM.

FIG. 4C is a contrast-enhanced SEM image of a system prepared using identical techniques to that used for FIG. 4B except strand T1.˜2th6(dt)+10T (SEQ ID NO:14) from Table 1 was put on the AuNP, leading to a 10-6-14 style of attachment between the AuNP and the array (FIG. 3A, 307). In this case, the resulting structure can be seen to have a structure that clearly shows the asymmetrical pattern expected from the model in FIG. 3B. The AuNPs can be seen to be in 3 neat horizontal rows with the spacing between the AuNPs of 28-30 nm.

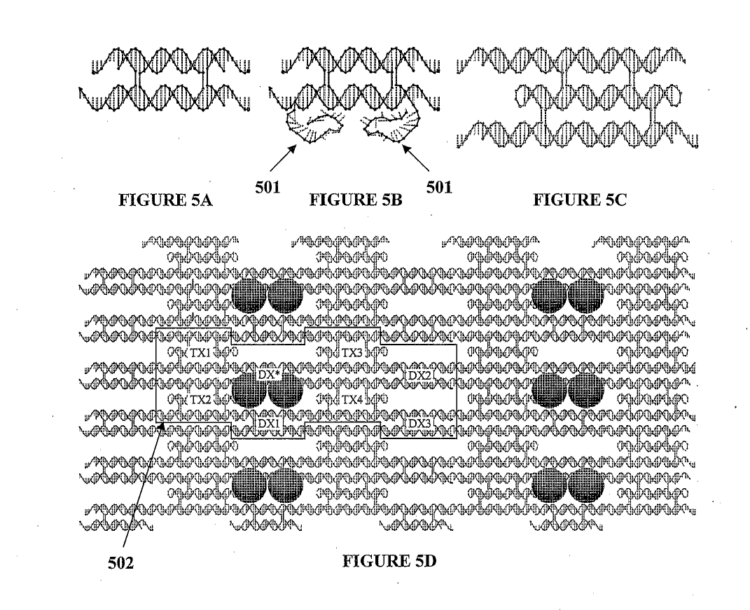

FIG. 5 shows an elementary quantum-dot cellular automaton. Two vertical wire-analogs are shown in FIG. 5D, each consisting of 6 AuNPs. The structure in FIG. 5D is based on a scaffold consisting of three types of branched DNA nanostructures, a double crossover molecule (DX), FIG. 5A, a DX with extended single-strands (DX*), FIG. 5B, and a triple crossover molecule (TX), FIG. 5C. The two, long single-strand regions on the DX* (501) provide attachment points for complementary strands of DNA with covalent thiol-based attachments to AuNPs. Each tile assembles into the array by matching the short single-strand DNA on the sides with the corresponding DNA on its nearest neighbors.

Thus, for example, the upper left corner of each DX would have a nucleotide sequence that is complementary to the DNA on the lower right corner of a TX. Similarly, the upper right corner of each DX would connect to the lower left corner of a TX etc. A primitive unit cell (502) is drawn on the array in FIG. 5D. Each tile in that cell would need to have a unique DNA sequence that would arrange those tiles unambiguously into the desired structure. The primitive cell consists of four TX molecules, three DX molecules, and one DX*, each of which has been labeled in FIG. 5D. The rest of the array would consist of repeated occurrences of those 8 different tiles. Such an array would assemble in a roughly neutral pH aqueous buffer such as borate buffer, and would require at least about a 10 mM concentration of divalent counterions such as Mg²⁺ during the hours of assembly. The AuNPs would, therefore, need to be covered with the zwitterion/DNA coating in order to avoid aggregation.

### Commercial Applicability

The DNA utilized in the preceding examples were for illustrative purposes and could have been substituted by RNA or countless other binding agents of biological or non-biological origin. The immediate utility currently envisioned for these coatings is for directing the assembly of NPs on branched DNA scaffolds for electronic, photonic and other applications. This class of coatings may be used on a wide variety of surfaces, including NPs of varying materials, larger particles, rods, and extended surfaces—wherever ion-mediated non-specific binding is not desired, but some other mode of attachment is wanted.

The nanoparticle coating can be used on a variety of different species that can be positioned in numerous DNA scaffolds and mechanical devices. Potential applications include as subjects for studies that require the organization of metallic or semiconducting NPs into complex structures on the nanometer scale, e.g., studies of optical, electronic, or catalytic properties of precisely positioned collections of NPs. Specific applications envisioned include: low power electronics, quantum dot cellular automata (QDCA), high density photonics, plasmon waveguides for transmission of photons through carriers smaller than their diffraction limit, and assembly of composite structures difficult to synthesize via alternative routes.

In the specification, the inventors have not attempted to exhaustively enumerate all possible variations. That alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. patents, and U.S. patent application Publications cited throughout this specification are hereby incorporated by reference as if fully set forth in this specification.

1. A nanoparticle coating comprising a zwitterion and a linker portion, wherein each of the zwitterion and the linker portion is separately attached to the nanoparticle.

2. The nanoparticle coating of claim 1, wherein the zwitterion is 3-(N,N-dimethyl(2-sulfidoethyl)ammonio)propane-1-sulfonate.

3. The nanoparticle coating of claim 1, wherein the linker portion is DNA.

4. The nanoparticle coating of claim 1, wherein the coating is attached to the nanoparticle by thiol attachment chemistry.

5. A composition comprising,
a nanoparticle;
a zwitterion; and
a linker portion;
wherein the zwitterion and the linker portion are separately attached to the nanoparticle.

6. The composition of claim 5, wherein the nanoparticle is a gold nanoparticle.

7. The composition of claim 5, wherein the zwitterion is 3-(N,N-dimethyl(2-sulfidoethyl)ammonio)propane-1-sulfonate.

8. The composition of claim 6, wherein the linker portion is selected from the group consisting of DNA, RNA, protein, organic polymer, and combinations thereof.

9. The composition of claim 6 further comprising a DNA scaffold.

10. The composition of claim 5, wherein the linker portion on the nanoparticle is bound to a scaffold to form a basic unit.

11. The composition of claim 10, wherein the basic unit is repeated and bound together in a predetermined pattern.

12. A method for preparing a nanostructure complex comprising,
(a) obtaining the composition of claim 6;
(b) combining (a) with a DNA scaffold.

13. A method for preparing a nanoparticle coating comprising,
attaching a linker portion to the nanoparticle; and
attaching a zwitterion to the nanoparticle.

14. A nanostructure complex comprising,
a nanoparticle;
a linker portion;
a plurality of zwitterions; and
a scaffold.

15. The nanostructure complex of claim 14, wherein the linker portion and the zwitterions are bound to the nanoparticle.

16. The nanostructure complex of claim 15, wherein the nanoparticle is a gold nanoparticle.

17. The nanostructure complex of claim 15, wherein the zwitterion is 3-(N,N-dimethyl(2-sulfidoethyl)ammonio)propane-1-sulfonate.

18. The nanostructure complex of claim 15, wherein the scaffold is a DNA scaffold.

19. The nanostructure complex of claim 18, wherein the DNA scaffold is a scaffold of branched DNA.

20. The nanostructure complex of claim 19, wherein the DNA scaffold comprises at least one Holliday junction.

21. The nanostructure complex of claim 15, wherein the scaffold is an inorganic scaffold.

22. The nanostructure complex of claim 21, wherein the inorganic scaffold is chosen from the group consisting of patterned metals, patterned semiconductors, patterned insulators, zeolites, carbon nanotubes, nanoribbons, nanowires, nanoparticles, and combinations thereof.

23. The nanostructure complex of claim 15, wherein the linker portion is DNA.

24. A composition comprising, a nanoparticle; and a nanoparticle coating of a zwitterion and a linker portion; wherein the zwitterions and the linker portion are separately attached to the nanoparticle.


SEQUENCE LISTING (14 sequences)

SEQ ID NO: 1 - DNA, 42 bp, Artificial Sequence
  Oligonucleotide
gcacgcaccaatcctaccgcaccgatccgaggtcaccgcctc

SEQ ID NO: 2 - DNA, 62 bp, Artificial Sequence
  Oligonucleotide
ggtttggcgttgagttttttctatgtgatctcctgcgtgcgaggcggacatcgagcggctac

SEQ ID NO: 3 - DNA, 28 bp, Artificial Sequence
  Oligonucleotide
gctcgatgtggatcttatgtctggaagt

SEQ ID NO: 4 - DNA, 83 bp, Artificial Sequence
  Oligonucleotide
ggtttggcgttgagttttttagacataagatcctgacctcggatcggactgtgttcactcacttcgatctagcctctgtgacg

SEQ ID NO: 5 - DNA, 50 bp, Artificial Sequence
  Oligonucleotide
agaggctagatcgaagtgagtgaacacagtggaatcttgtgaaggtctgc

SEQ ID NO: 6 - DNA, 80 bp, Artificial Sequence
  Oligonucleotide
ggtttggcgttgagttttttttcacaagattcctgcggtaggattggacgacttttgtcgtggagatcacataggaggta

SEQ ID NO: 7 - DNA, 42 bp, Artificial Sequence
  Oligonucleotide
ctaggcacctcttcggaggcaccttgcagcgtacaccgaccg

SEQ ID NO: 8 - DNA, 42 bp, Artificial Sequence
  Oligonucleotide
tgatatatgaacctgcctagcggtcggactagctcgtacctc

SEQ ID NO: 9 - DNA, 28 bp, Artificial Sequence
  Oligonucleotide
cgagctagtggtagtcagataccgtcac

SEQ ID NO: 10 - DNA, 63 bp, Artificial Sequence
  Oligonucleotide
gtatctgactacctgtacgctgcaaggacattcctaaccgccatacctatcgcttgtacttcc

SEQ ID NO: 11 - DNA, 50 bp, Artificial Sequence
  Oligonucleotide
acaagcgataggtatggcggttaggaatgtggtcgttatagatgtattgc

SEQ ID NO: 12 - DNA, 60 bp, Artificial Sequence
  Oligonucleotide
atctataacgacctgcctccgaagaggactcgttttcgagtggttcatatatcagtagcc

SEQ ID NO: 13 - DNA, 20 bp, Artificial Sequence
  Oligonucleotide
acgccaaacctttttttttt

SEQ ID NO: 14 - DNA, 16 bp, Artificial Sequence
  Oligonucleotide
caaacctttttttttt